(19) United States
(12) Patent Application Publication
(10) Pub. No.: US 2021/0292543 A1
(43) Pub. Date: Sep. 23, 2021

(54) COMPOSITE PACKAGING FOR EXTREME ENVIRONMENTS

(71) Applicant: Alliance for Sustainable Energy, LLC, Golden, CO (US)

(72) Inventors: David Samuel GINLEY, Evergreen, CO (US); Dan Austin PLATTENBERGER, Denver, CO (US)

(21) Appl. No.: 17/206,104

(22) Filed: Mar. 18, 2021

Related U.S. Application Data
(60) Provisional application No. 62/991,503, filed on Mar. 18, 2020.

(51) Int. Cl. C08L 61/16; C08L 67/03; C08L 79/04

(52) U.S. Cl. CPC C08L 61/16; C08L 79/04; C08L 67/03

(57) ABSTRACT

Disclosed herein are new compositions of matter and methods useful for the packing of electronics in extreme environments.

### CROSS-REFERENCE TO RELATED APPLICATIONS

This application claims priority under 35 U.S.C. § 119 to U.S. provisional patent application No. 62/991,503 filed on 18 Mar. 2020, the contents of which are hereby incorporated in their entirety.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND

A new generation of lightweight, cost-effective materials that are capable of performing in harsh environments are required to enable a variety of developing and impactful technologies. In hydrogen fuel cells, for example, lightweight and inexpensive materials that can survive and cycle indefinitely at 225° C. would be transformative to that technology. In high-temperature power electronics or in hydrogen storage, novel, non-traditional heat exchange materials can enable more powerful and more efficient processes. Likewise, materials limitations are among the highest hurdles to overcome in concentrated photovoltaics or in solar thermal energy storage applications, where temperatures are extreme (and fluids may be highly corrosive).

Another illustrative example is in the subsurface, which is potentially an enormous source of energy that could provide reliable, flexible baseload electricity, direct heat, and storage. The Department of Energy concluded that geothermal capacity in the United States could increase substantially if advances were made to materials that are used for casings in geothermal wells. Not only do current casings and cement account for approximately one quarter of the cost of a geothermal project, they are susceptible to temperature-accelerated corrosion (up to 400° C. and 4 M NaCl) and collapse over time, which greatly increases the risk and uncertainty of a project.

In many applications, the common solution to materials shortcomings is to engineer metal alloys to address specific concerns involving reactivity or resilience but those materials are inherently dense, expensive, and difficult to manufacture. In addition, metals have inherently high coefficients of thermal expansion (CTE), which can cause complications in applications requiring thermal cycling (e.g., casing collapse in geothermal energy wells). It is clear that there is a need for new materials to address these fundamental issues.

Electronic components are deployed in a wide range of environments including, drill pipe for geothermal, solar cells, fuel cells, batteries, and vehicles. All of which have environments that can be considered extreme in the sense of temperature (>200° C.), chemical environment acids and bases and other corrosive materials (Cl, SO₂, S, etc) and mechanical stresses, both static and dynamic. In many cases the packaging of components for these environments is expensive or does not even exist, thereby limiting the deployability or lifetime of the technology. The integration of new materials potentially can create tunable packaging with performance characteristics, manufacturability and lower costs than existing packaging materials.

Currently, for some applications, concrete or ceramic coatings are used which are typically expensive and brittle. The use of electronics in extreme environments is rapidly increasing. An example is the use of electronics in down hole sensing for geothermal and oil and gas. Currently the use of electronic devices and packaging is limited up to about 170° C. while the desired operational temperature is closer to 400° C. in an environment that also include other extreme pressures and other forces. Similar extreme environments can be found in the applications of concentrator PV, fuel cells, batteries and a number of other technologies. Until recently, polymers did not exist that could be used for the packaging of electronics in these kinds of extreme environments.

### SUMMARY

In an aspect, disclosed herein are compositions of matter comprising ceramics and/or polymers for high-temperature environments. In an embodiment, the compositions are useful for the packaging of sensor electronic circuits useful for sensing in extreme environments.

Other objects, advantages, and novel features of the present invention will become apparent from the following detailed description of the invention when considered in conjunction with the accompanying drawings.

### BRIEF DESCRIPTION OF THE DRAWINGS

FIG. 1 depicts the performance characteristics of various plastics.

FIGS. 2a and 2b depict exemplary methods for making the materials disclosed herein. FIG. 2a depicts a system using an ultrasonic atomizer. FIG. 2b is a close-up of an embodiment of an ultrasonic atomizer with detail depicting an atomizer outlet, liquid film, nanomaterials, capillary waves, droplets, solvent evaporation and deposition of the polymer or other composite material onto a substrate.

FIG. 3 depicts embodiments of polymer/inorganic filler composites.

FIG. 4 depicts characteristics of filler compositions and their dielectric constants, dielectric strength, thermal conductivities and coefficient of thermal expansion (CTE).

FIG. 5 depicts packaging formulations of exemplary FPE polymer and filler with various embodiments of loading weight percentages.

### DETAILED DESCRIPTION

In an embodiment, disclosed herein are compositions of matter comprising materials that combine polymer and ceramics to create entirely new materials that are more resilient and cheaper to make than existing materials. These materials can be used in a variety of applications in extreme environments.

Currently available downhole drilling tools have maximum temperature ranges of about 175° C. Although these tools can be used in geothermal drilling with circulating cooling fluid, this is not often done because of the high cost of replacement should the operation lose circulation. Using compositions of matter disclosed herein would enable the manufacture of tools that are the first to exceed current temperature limitations and operate sustainably at 250° C., thus lowering the risk for use in higher-temperature geothermal wells.

The current state of the art in active devices is about 150° C. for devices based on Si, SiC, and SiO₂. Dielectric materials can barely make the current 150° C. limit due to grain-boundary and ion-migration effects.

While ceramics alone are generally chemically inert, capable of withstanding extreme temperatures, and very strong in compression, they are of limited use in many mechanically demanding applications due to their brittleness and lack of tensile strength. Once fractures are formed, they propagate, nearly unimpeded, along grain boundaries until failure occurs. Likewise, there are many polymers that are inexpensive and chemically/thermally resilient, yet they are not strong enough (particularly, in compression) to be of use in many applications. The optimization of chemical resistance, mechanical properties, and high-temperature stability is uniquely addressable by composites of these two classes of materials. For many extreme applications, lightweight and chemically inert materials capable of operating at 150° C. would be useful, 250° C. would be transformative, and 300-400° C. would be a superior improvement over existing materials.

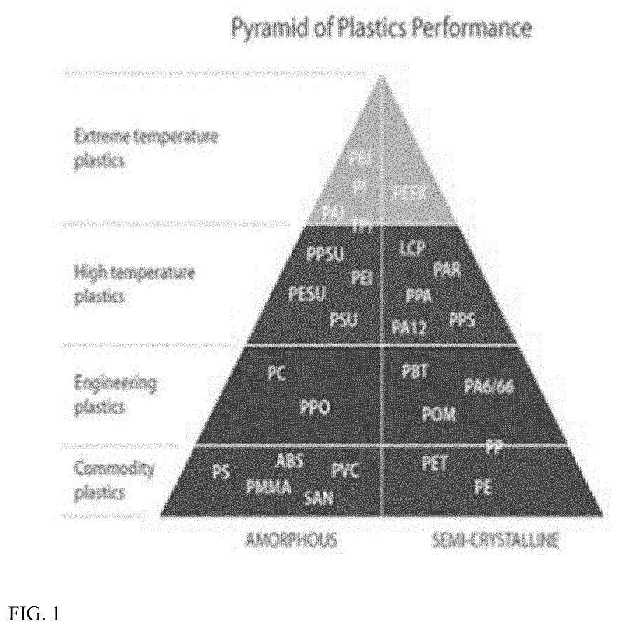

There is broad interest in developing novel ceramics and/or polymers for high-temperature environments. A number of polymers such as PEEK, polybenzimidazole, and other imidazoles and fluoropolymers have been shown to function at 400° C. and, in combination with glass or other composites, to work even above those temperatures. The hierarchy of polymer temperature rating is depicted graphically in FIG. 1 and, in an embodiment, informs a selection of PBI (Polybenzimidazole) and PEEK (Polyether ether ketone) derivatives to act as organic matrices to be reinforced with ceramic, carbon-based, and/or oxide-based nanofibers. In an embodiment, optimum organic and inorganic materials are combined in a composite, whereby the potential mechanical properties, chemical properties, manufacturing techniques, and cost considerations for various applications will be determined.

For sensing systems to be useful in extreme environments such as those having high temperatures, mechanical stresses, and corrosive environments, packaging circuit elements and other components so that the circuit elements are still capable of functioning is a necessity. Disclosed herein are new approaches to the development and implementation of robust packaging materials for electronic circuits and other sensing devices. The robust sensing systems disclosed herein consist of combining new high temperature polymers with inorganic (primarily oxide) nano materials. The combination can achieve temperature stability to 400° C., mechanical properties including hundreds of g transients and chemical stability to acids, bases and other corrosives. To assure integration with the sensing systems, the surface chemistry of the oxide or other nano materials can be modified to assure strong interfacial performance. Properly chosen nano materials can control the conductivity, photo activity, strength and chemical activity of the nano materials and composite. In an embodiment, the materials disclosed herein are polymer-ceramic composites.

In an embodiment, the superior performance of the discrete and integrated packages disclosed herein demonstrate sustainable operational temperatures of 250° C. Both the sensors and dielectrics and interface electronics will be tested by cycling from room temperature to 250° C. under associated mechanical and pressure environments, where possible, and their performance is maintained for at least 10 cycles.

In an embodiment, disclosed herein is the demonstration of a new materials set for active and passive circuit elements for downhole sensor and power electronics capable of higher performance and life than existing materials, as well as demonstrated operation at a minimum of 250° C., which is well above the current limit of 150° C.

In an embodiment, disclosed herein are devices useful to develop critical contacts and packaging components tailored to the geothermal environment, based on non-coupled devices. This includes development of new oxide/dielectric materials ideally processible by solution, atomic layer deposition, or vapor-phase epitaxy approaches that show no fracture and very low ionic migration at up to 300° C. with the desired dielectric properties. Some examples of such materials are borosilicate glasses, which can be formulated to work at 400° C., and some of the projected high-K dielectric materials such as ZrSiO₄ and SrHfO₂, both of which have excellent dielectric properties up to 300° C. In an embodiment, materials disclosed herein will be coupled with metallizations to enable full circuits capable of high-temperature operation.

In an embodiment, the materials disclosed herein comprise brazed ceramic compositions. In an embodiment, the materials disclosed herein comprise phosphate-based glasses, and alkaline earth-based oxide glasses. In an embodiment, the materials disclosed herein comprise Barium, Boroaluminosilicate glass, titania, BiScO₃—BaTiO₃ composites, and CaZrO₃—SrTiO₃ composites. In an embodiment, the materials disclosed herein comprise fluorene polyester (FPE) polymers with Al₂O₃ microparticles as a filler. In an embodiment, the materials disclosed herein comprise FPE polymers with TiO₂ particles as a filler. In an embodiment, the materials disclosed herein comprise FPE polymers with TiO₂ fibers as a filler. In an embodiment, the materials disclosed herein comprise FPE polymers with BN particles as a filler. In an embodiment, the materials disclosed herein comprise FPE polymers with SiO₂ particles as a filler.

In an embodiment, the materials disclosed herein have a T_{g} of greater than 330° C.

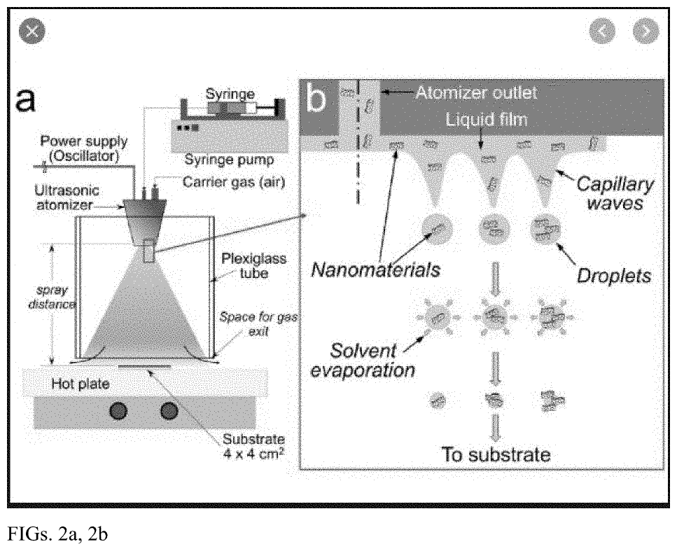

In an embodiment, the FPE materials disclosed herein are made using FPE composites that have at least up to 10% oxide that are solution processed. In an embodiment, the solvents used are tetrahydrofuran (THF) and/or dimethylacetamide (DMA). In an embodiment the method used to make the FPE materials disclosed herein comprises a spraying step. In an embodiment the method used to make the FPE materials disclosed herein comprises a spraying step, see FIG. 2a and FIG. 2b, for example.

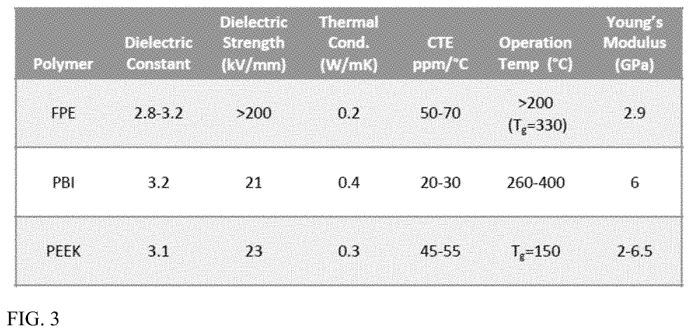

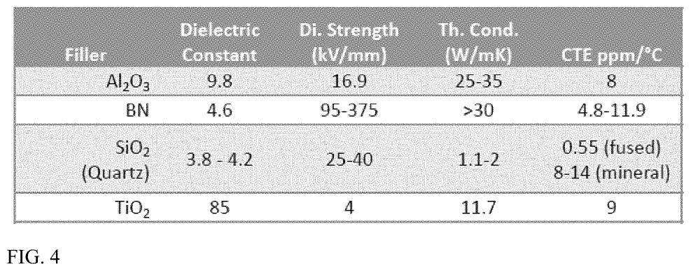

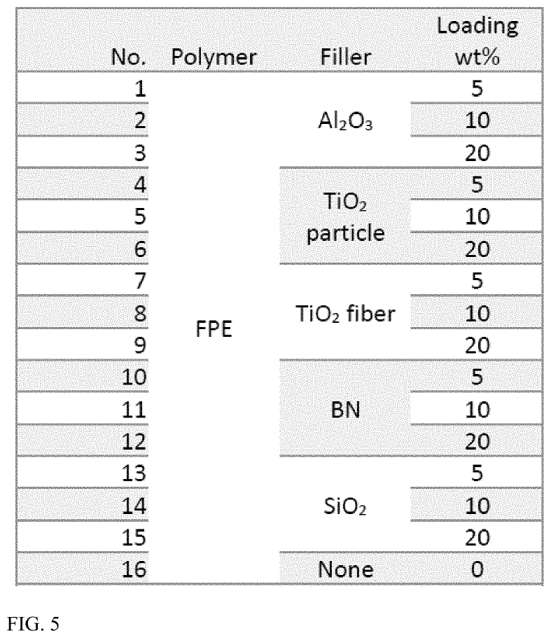

In an embodiment, the polymer/inorganic filler composites disclosed herein are optimized for both mechanical and electrical robustness and comprise polymers that are capable of functioning in temperatures exceeding 400° C. In an embodiment, the fillers are tested for their compatibility with polymers and for their ability to enhance mechanical properties. See FIG. 3 for embodiments of polymer/inorganic filler composites. See FIG. 4 for characteristics of filler compositions and their dielectric constants, dielectric strength, thermal conductivities and coefficient of thermal expansion (CTE). FIG. 5 depicts packaging formulations of exemplary FPE polymer and filler with various embodiments of loading weight percentages.

In an embodiment, the sensors/sensor packages disclosed herein will be interfaced with high-temperature SiC interface electronics and will be packaged within drilling modules. In an embodiment, semiconductor/metal/dielectric structures, their packaging, including solder bonds and dielectric packaging are disclosed herein.

In an embodiment, the sensors/sensor packages disclosed herein are useful for the electrocrushing of rock.

The foregoing disclosure has been set forth merely to illustrate the invention and is not intended to be limiting.

We claim:

1. A composition of matter comprising polymers resistant to degradation at temperatures greater than 200° C.

2. The composition of matter of claim 1 wherein the polymers are resistant to degradation at temperatures greater than 300° C.

3. The composition of matter of claim 1 wherein the polymers are resistant to degradation at temperatures greater than 350° C.

4. The composition of matter of claim 1 wherein the polymers are resistant to degradation at temperatures greater than 400° C.

5. The composition of matter of claim 1 wherein the polymers further comprise a filler.

6. The composition of matter of claim 5 wherein the filler comprises Al₂O₃.

7. The composition of matter of claim 5 wherein the filler comprises BN.

8. The composition of matter of claim 5 wherein the filler comprises SiO₂.

9. The composition of matter of claim 5 wherein the filler comprises TiO₂.

10. The composition of matter of claim 5 wherein the filler comprises a particle.

11. The composition of matter of claim 5 wherein the filler comprises a fiber.

12. The composition of matter of claim 1 wherein the polymers comprise fluorene polyester (FPE).

13. The composition of matter of claim 1 wherein the polymers comprise polybenzimidazole (PBI).

14. The composition of matter of claim 1 wherein the polymers comprise polyether ether ketone (PEEK).

15. The composition of matter of claim 1 wherein the polymers comprise Barium, Boroaluminosilicate glass, titania, BiScO₃—BaTiO₃ composites, and CaZrO₃—SrTiO₃ composites.

16. The composition of matter of claim 1 used for the packaging of sensor electronic circuits.

17. The composition of matter of claim 2 used for the packaging of sensor electronic circuits.

18. The composition of matter of claim 3 used for the packaging of sensor electronic circuits.

19. The composition of matter of claim 4 used for the packaging of sensor electronic circuits.

20. A method for making a composition of matter comprising polymers resistant to degradation at temperatures greater than 200° C. wherein the polymers are selected from the group consisting of FPE, PBI and PEEK and wherein the method comprises the step of spray coating the polymers onto a substrate.
